(19) United States
(12) Patent Application Publication
(10) Pub. No.: US 2011/0282805 A1
(43) Pub. Date: Nov. 17, 2011

(54) SECURITIES TRADING METHOD

(76) Inventor: Peter Metford, Mississauga (CA)

(21) Appl. No.: 13/145,492

(22) PCT Filed: Jan. 21, 2010
(86) PCT No.: PCT/CA2010/000098

§ 371 Date: Jul. 20, 2011

Related U.S. Application Data
(60) Provisional application No. 61/146,180, filed on Jan. 21, 2009.

(51) Int. Cl. G06Q 40/00

(52) U.S. Cl. 705/36 R

(57) ABSTRACT

A method and storage medium for trading securities comprise providing and selecting a first trading template; receiving via a communication network data relating to a trade relating to the first trading template; modifying the first trading template in accordance with a shift, the shift for adjusting the first template; automatically communicating via a network with a trading server to receive data for evaluating at least a condition precedent of the shifted trading template; and when the condition precedent is met, automatically communicating via the network with the trading system to request a first trade thereon in accordance with the first trading template. A system for implementing the invention includes a storage medium, an input port for receiving data, a communication port for receiving data via a communication network and a processor for modifying the first trading template. The invention provides for advantageous selection and implementation of trading strategies.

### FIELD OF THE INVENTION

The present invention relates generally to securities and derivatives trading systems; and more specifically, to a computer-based trading system.

### BACKGROUND OF THE INVENTION

Securities and derivatives are often listed on a financial exchange, an organized and officially recognized market on which products can be bought and sold. Traders and brokers purchase and sell products electronically through a trading front end system, which allows them to manually enter buy and sell orders at specific prices. U.S. Pat. No. 6,938,011 is an example of a technology that facilitates this process. Many front end systems offer comprehensive scripting languages, such as EasyLanguage™ offered by Tradestation™ Securities, which allow users to program entry signals based on specific market environments, often initiated by the behavior of chart-based indicators or price patterns. Scripting languages will, in addition, allow the user to program management parameters designed to automate the exit of any positions based on specific triggering events outlined by the user. Scripting languages are, by nature, comprehensive, allowing the user to build novel trading strategies, with no constraints on complexity. However, effective use of scripting languages require a great deal of expertise in the specific language offered by the front end trading system, and because of the inherently complex nature of these languages it can take several years for a user to become proficient. Additionally script-based programming is intrinsically time-consuming due to the comprehensive nature of the programming language. Each scripting language offered by a front end trading system is proprietary, and will operate only when interfacing with its respective front end partner, or in some cases two or more front end systems will allow there scripting languages to be compatible. In an attempt to retain the complexity and comprehensiveness of a scripting language and eliminate the need for an expertise in programming some front end systems, Ninja Trader™ for example, have attempted to create a graphical user interface (GUI) that allows users to access some of the complexities of a scripting language via an intermediary program. These scripting language GUIs allow traders to automate chart-based entries with some of the comprehensiveness offered by scripting languages and also allow automated order management.

Many traders do not, in general, use front-end execution platforms that also offer scripting languages or scripting language GUIs, therefore there is a need for a GUI that is able to automate entry and exit orders that is not platform dependent. Furthermore, many traders require a level of order management complexity that is not currently available in any script-based GUI.

Therefore, there exists a need for a trading system which allows traders the ability to quickly build sophisticated strategies, without learning a complicated scripting language. Furthermore there is a need for the ability to reuse strategies under diverse market conditions, so traders do not have to rebuild strategies each time they want to change their entry size, trade orientation, trade size, or trade price. There is also a need to execute custom made strategies with a trading engine that implements commonly used trading principles, for example; the management of partial fills, adjustment of profit/stop trade quantities, and detecting overfills. The present invention allows the trader to create flexible and sophisticated trading strategy templates through an intuitive graphical user interface. The templates are product, price, trade size and orientation independent, allowing the user to apply the templates to a broad number of market environments. In addition, the current invention is front-end independent, allowing strategies to be universally recognized.

### SUMMARY OF THE INVENTION

The invention seeks to provide a method comprising: providing at least a trading template; selecting a first trading template from the at least a trading template; receiving via a communication network data relating to at least a trade relating to the first trading template; modifying the first trading template in accordance with a shift, the shift for adjusting the first template; automatically communicating via a network with a trading server to receive data for use in evaluating at least a condition precedent of the shifted trading template; and, when the at least a condition precedent is met, automatically communicating via the network with the trading system to request a first trade thereon in accordance with the first trading template.

The invention further seeks to provide storage medium having stored thereon data for when executed resulting in providing at least a trading template; receiving from a user a selection of a first trading template from the at least a trading template; receiving via a communication network data relating to at least a trade relating to the first trading template; modifying the first trading template in accordance with a shift, the shift for adjusting the first template; automatically communicating via a network with a trading server to receive data for use in evaluating at least a condition precedent of the shifted trading template; and, when the at least a condition precedent is met, automatically communicating via the network with the trading system to request a first trade thereon in accordance with the first trading template.

The invention further seeks to provide a system comprising: a storage medium having stored thereon first data relating to at least a trading template; an input port for receiving input data for selecting a first trading template from the at least a trading template; a communication port for receiving via a communication network data relating to at least a trade relating to the first trading template; a processor for modifying the first trading template in accordance with a shift, the shift for adjusting the first template, for automatically communicating via the communication port and a network with a trading server to receive data for use in evaluating at least a condition precedent of the shifted trading template, and for when the at least a condition precedent is met, automatically communicating via the network with the trading system to request a first trade thereon in accordance with the first trading template.

The invention further seeks to provide a method comprising: providing at least a trading template; selecting on a first system a first trading template from the at least a trading template; automatically communicating via a network with a trading server to receive data for use in evaluating on the first system condition precedents of the first trading template the data received from the trading system; when the condition precedents are met, automatically communicating via the network from the first system to a trade execution system to request a first trade thereon; and, automatically managing the first trade based on data received from the trading server.

The invention further seeks to provide a method comprising: on an automated trading system a) defining a root trigger; b) defining execution conditions for said trigger; c) defining a market or limit order; d) defining exit conditions; and on a second other system e) executing said trigger at a trigger price in dependence upon the definitions provided in (a), (b), (c), and (d).

The invention further seeks to provide a method comprising: defining a trailing strategy by: a) providing to the automated system a trailing behavior; b) providing to the automated system one or more signal events; c) providing to the automated system trailing parameters; d) providing to the automated system subsequent trailing behavior; and e) automatically applying the trailing strategy using the automated system.

### BRIEF DESCRIPTION OF THE DRAWINGS

It will now be convenient to describe the invention with particular reference to one embodiment of the present invention. It will be appreciated that the figures relate to one embodiment of the present invention only and are not to be taken as limiting the invention.

FIG. 1 is a flow chart, showing a method for trading securities, according to one embodiment of the present invention;

FIG. 2 is a flow chart, showing a method for defining trade parameters within a method for trading securities, according to one embodiment of the present invention;

FIG. 3 is a flow chart, showing a method for defining a trigger complex within a method for trading securities, according to one embodiment of the present invention;

FIG. 4 is a flow chart, showing a method for defining a trailing strategy within a method for trading securities, according to one embodiment of the present invention;

FIG. 5 is a flow chart, showing a template example within a method of defining trade parameters, according to one embodiment of the present invention; and

FIG. 6 is a flow chart, showing a template instantiation within a method of defining trade parameters, according to one embodiment of the present invention.

### DETAILED DESCRIPTION OF THE DRAWINGS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

A template is used to specify how a system responds to specific market events such as changes in the price of a security, fluctuations of advertised bids/offers, and volume events. The system's individual templates employ Trigger Complexes that specify an exact manner in which the system attempts to remove liquidity from a financial instrument. Trigger Complexes initiate when their Trigger parameters are satisfied. Triggers can be satisfied by the bid or ask which is closest to the front of the market (top of book) reaching a designated price, or when an amount of advertised shares at the top of book crosses below a designated threshold. Triggers can also be satisfied by a specific amount of volume traded at a specific price. Also a trigger can be satisfied by a combination of top of book size, price and volume prints. Once a trigger is satisfied, an order is launched which is sent immediately to market or cross the market by a designated amount with either a day order (an order which will remain until the market closes), an immediate or cancel order, or a Good until Cancel order.

There are three classes of trade template types: Breakout, Counter-trend, and Intellitrade. Breakout trades attempt to remove liquidity on entry and utilize a Trigger Complex to enter positions and will buy the designated product if the price input is at or higher than current advertised offer, and will enter a short sell if the price input is at or lower than the current advertised bid. Counter-trend trades add liquidity and trades will advertise one or more entry order(s), and will therefore be buying when the price inputted is at or lower than the current advertised bid, and will be selling when the price inputted is at or higher than the current advertised offer. Lastly, Intellitrades allow the user to manually enter a trade through the front end trading system, at which point the system collects information about that trade and uses this information to automatically manage the risk on that trade in accordance to the profit and stop-loss parameters that the user entered into their template.

Templates are organized into an allocation tree structure, and operate on two levels, entry and exit allocations. Each entry or exit allocation is assigned a percentage value when it is added to the tree, and this value indicates a proportional percent of the entry size assigned to the allocation. The user must allocate 100% of their entry allocation but can divide this 100% in any manner that they see fit, allowing for complex flexibility. Intellitrades will automatically have one 100% entry allocation as the position is entered manually. Each parent entry allocation can allocate between 0-100% of its position to child exit allocations, giving the user great flexibility in risk management. Each entry can have an independent offset, and each exit can have an independent profit strategy and stop strategy offset. Once the user selects a price at which the template will be launched the templates offsets are populated with prices based on their distance from the launch price. The user can launch the same template again at a different price or product and the offsets will be populated with different and newly relevant prices. The user can also launch a template with varying trade sizes and these sizes will be proportionally split to the entry allocations and exit allocations of the tree in accordance to their respective allocation percentages. The templates can also be used for both long and short entries, which the user can either specify to the system, or the system can automatically determine at launch time. The user can also specify cancel conditions on the entry allocation in a tree, which will cancel the entry after a specified amount of time has elapsed since launch. The user can also set timed exits, which will exit a position by activating a selected Trigger Complex at a specified offset from the best bid or offer after a specified amount of time has elapsed since the exit allocation was assigned a filled quantity from its parent entry allocation.

Any profit, stop or timed exit strategy can have trailing behavior assigned to it. The user can define a trailing behavior based on price change constants, chart information, or a preset algorithm. Once the trailing signals specified in the trailing strategy are detected, then the price of the associated exit strategy will change in accordance with the rules specified in the shift of the trailing strategy.

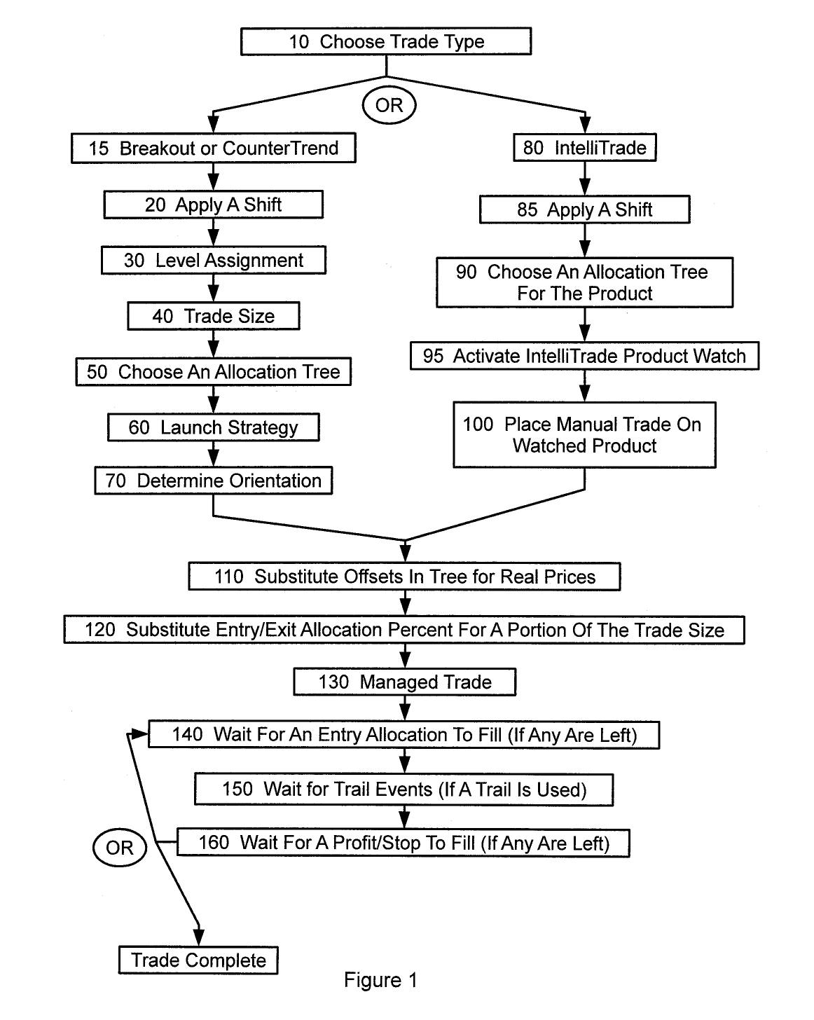

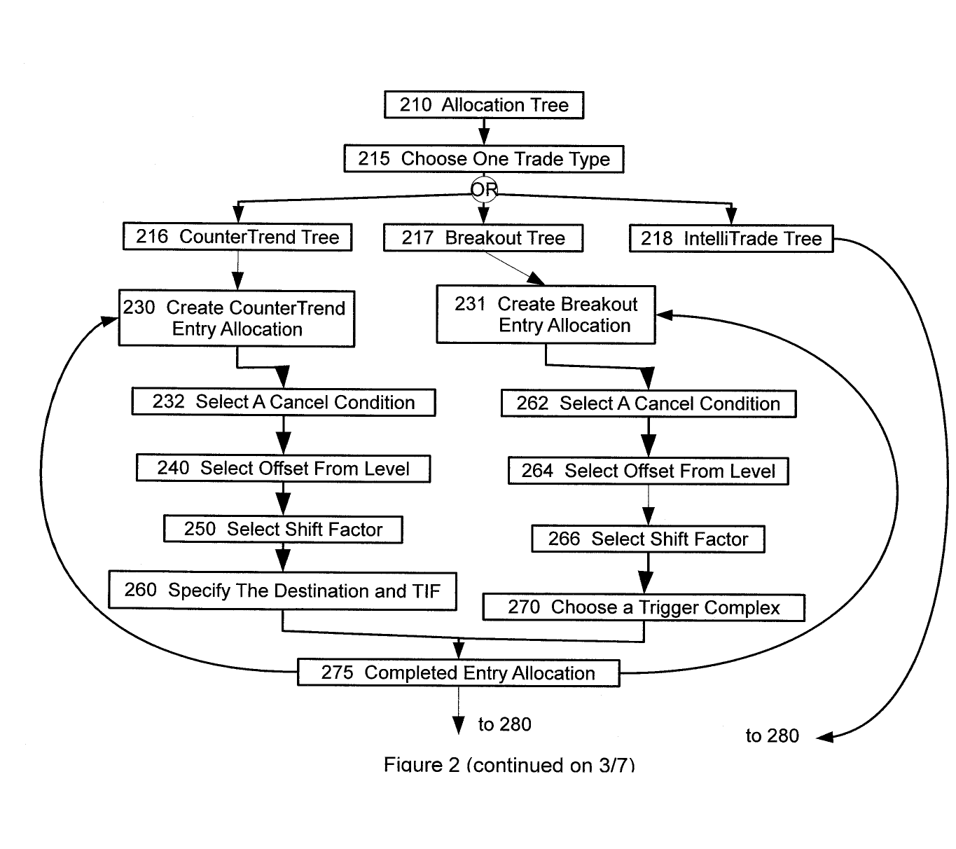

With reference to FIG. 1 and according to one embodiment of the present invention, a method for trading securities is detailed in Steps 10 to 160.

### Choose a Trade Type

In Step 10, the user chooses the trade type. The trade type determines how the trade will be managed by the system (See Step 220 for further description).

In Step 15, the user has chosen Breakout or CounterTrend as the trade type.

### Apply a Shift

In Step 20, shifts can be applied to the allocation tree if the user would like to expand the price offsets of certain parts of the tree. The way that a tree expands is determined when the tree is designed. The shift factor is used to specify how an entry or exit allocation offset will change once a shift is applied to the tree. Three types of shifts may be applied to a CounterTrend or Breakout tree, that is entry, profit and stop shifts. When a shift is applied to the tree, it enlarges the offset of the allocation, thereby changing the execution price of the allocation. An arithmetic shift factor is multiplied by the shift that the user applies to a tree and this value is then added to the current offset. A geometric shift uses the shift factor as the base, and the user's shift input as the exponent, and this value is then added to the current offset. The shift factor allows the trader to quickly change the offsets of a tree after the tree is created. Note that a shift factor of zero will prevent the offset of an allocation from changing if a shift is applied to the tree. Shifts are useful since they allow the user to quickly modify the price offsets in a tree, making it easier to use a single tree for many different trading strategies. For example, if a trading strategy is created that has a profit order of one cent with an arithmetic shift factor of two, the profit order will shift by two price increments each time a shift increment of one is applied.

### Define Trade Parameters

In Step 30, the “level” is assigned. The level is simply a price point on a securities product. The level is very important since it gives the whole Allocation Tree described in Steps 210 to 360 and all of its components, in particular Trigger Complexes, described in Steps 410 to 500, and Trailing Orders, described in Steps 510 to 600, a reference price to base all the offsets from. The use of offsets in strategy development is essential since it allows the strategy templates to be used with any reference price. Details of how offsets are used with a level are specified in Step 110. The level may be entered manually by the user or may be provided by a number of different sources such as a charting package, front end trading system, signal generation program, or specific current market prices such as the best bid or best offer price.

In Step 40, the user specifies the trade size, which is the total number of contracts or shares that will be applied to the allocation tree for management. See step 120 for a further description of how the trade size is applied to an allocation tree.

In Step 50, the user's choice of trade type produces the creation of an allocation tree of type CounterTrend or Breakout. The process then follows Steps 200 to 360, which specifies the steps for creating an Allocation Tree, after which point the process will return to the next step, Step 60.

In Step 60, the user launches the trading strategy by informing the system that their strategy has been specified and is ready to be executed. At any time, the user can notify the system to stop managing a trading strategy, and this will cause the system to cancel all orders issued by the system, while retaining any net position acquired during strategy management. If the user would like to offset the net position acquired during management in addition to cancelling all system orders, then this option is also available to them. The user may also inform the system that they want to activate or deactivate multiple strategies at the same time.

In Step 70, the orientation, whether the trade is long or short, is determined. This is accomplished by using the trade type (Breakout or CounterTrend), best bid/offer and the level price. If the level price is less than or equal to the best bid then the CounterTrend orientation will be long and the Breakout orientation will be short. If the level price is greater than or equal to the best offer then the CounterTrend orientation will be short and the Breakout orientation will be long. The system ensures that the managed strategies remain consistent with the orientation rules for Countertrend and Breakout. For example, the CounterTrend needs to place a limit order in the market, and this order should never buy at a price greater than or equal to the best offer or sell at a price lower than or equal to the best bid, otherwise it would be executed immediately. The system automatically checks for this condition, and prevents the trade from being issued if any of the negative entry allocation offsets in the tree would cause this to happen. Once the orientation is determined for the entry allocation(s), the exit allocation(s) in the tree will always have an opposite orientation to their parent entry. Also, the orientation of the components, in particular the Trigger Complexes and the Trailing Strategy in the tree will match the orientation of the Exit Allocation they belong to.

### Choose a Trade Type

In Step 80, the user has chosen Intellitrade as the trade type.

### Apply a Shift

In Step 85, two types of shift may be applied to an IntelliTrade Tree, that is, profit or stop shifts. When a shift is applied to the tree, it enlarges the offset of the Allocation, thereby changing the execution price of the Allocation. An arithmetic shift factor is multiplied by the shift that the user applies to a tree and this value is then added to the current offset. A geometric shift uses the shift factor as the base, and the user's shift input as the exponent, and this value is then added to the current offset. The shift factor allows the trader to quickly change the offsets of a tree after the tree is created. Note that a shift factor of zero will prevent the offset of an Allocation from changing if a shift is applied to the tree. Shifts are useful since they allow the user to quickly modify the price offsets in a tree, making it easier to use a single tree for many different trading strategies.

### Define Trade Parameters

In Step 90, the user's choice of trade type in Step 10 results in the creation of an allocation tree of type Intellitrade. The process then follows Steps 200 to 360, which specifies the steps for creating an Allocation Tree, after which point the process will return to the next step, Step 95.

In Step 95, IntelliTrade Product Watch is activated. This is a safety over-ride feature that prevents the user from issuing system-managed trades when they intend to trade manually. If the system is in semi-auto mode then the user must specially indicate to the system that the next trade placed by the user will be managed. The user can also place the system into full-auto mode which will cause the system to automatically manage any trades entered by the user. The system also ensures that the user can always exit a currently managed IntelliTrade manually, without launching another managed trade. This is done by tracking the net position and only allowing new IntelliTrades to be managed if they would add to the current net position.

In Step 100, manual trade is placed on the watched product. The user can use their front end trading system to enter an order into the market. The order entry requirements are maintained by the front end trading system, and once the user enters a valid order the system is able to capture this information for use in a trading strategy. All orders contain information such as orientation (long or short), trade size and execution price. The order execution price is used for the price of the “level” as described in step 40, the orientation of the order is used to determine the orientation of the Exit Allocations in the IntelliTrade Allocation Tree detailed in step 70, and the trade size of the order is applied to the Allocation Tree as detailed in step 120.

### Manage a Trade

In Step 110, the offsets in the Allocation Tree are substituted for real prices. The level price is used to substitute all of the offsets in the Allocation Tree for real prices. The positive offsets in the Allocation Tree place entry orders farther from the current market price, while the negative offsets place the entry order closer to the market price. If the level price is lower than or equal to the current best bid, then the offsets in each entry allocation are subtracted to the level price to determine a real price for the entry allocation. The offsets are added if the level is higher than or equal to the current best offer price. Once each entry allocation has been assigned a price, the child Exit Allocations and associated components can be assigned real prices by applying their offsets from the parent Entry Allocation price. The orientation of the exit allocations are always opposite to their parent entry allocation. The price of the profit order is determined by adding the profit order offset to the Entry Allocation price if the Entry Allocation has a long orientation and subtracting the profit order offset if the Entry Allocation has a short orientation. The offset for the root trigger price of the Trigger Complex that is assigned to a stop-loss order is determined by subtracting the stop offset from the Entry Allocation price if the Entry Allocation has a long orientation and adding the stop offset if the Entry Allocation has a short orientation. Once the root trigger price is determined for the Trigger Complex, all other Trigger offsets are subtracted if the orientation of the Trigger Complex is short and added if the Trigger Complex is long. The orientation of the trigger complex always matches its container Exit Allocation orientation.

In Step 120, the Entry/Exit Allocation percent is substituted for a portion of the trade size. The percentage of each entry allocation in the tree indicates the proportion of the trade size that will be assigned to it. This allows any trade size to be used on an allocation tree. The trade size is partitioned in a best-effort to the Entry/Exit Allocations, rounding the size when needed. Once each entry allocation has been assigned a trade size, the exit allocations can then be assigned a maximum size they will be assigned to manage which is extrapolated from the parent entry allocation once it is filled.

In Step 130, the allocation trees have all the information necessary to manage the trade. If the tree type is a CounterTrend, limit orders are physically placed in the market to match the Entry Allocation prices assigned in Step 110. If the orientation is a breakout, then the triggers assigned to the Entry Allocations will be active and will wait for a trigger event to occur in order to execute the physical orders described in the Trigger Complex that is associated with the Breakout Entry Allocation. If the tree type is IntelliTrade, then nothing is done in this step, since the entry order has already been placed in the market by the user.

In Step 140, the trading system waits for an Entry Allocation to fill. Once an entry allocation is filled, the Exit Allocations are assigned a quantity to manage. The order in which fills are assigned is laid out in the allocation tree, and can be changed at design time. Allocations with a higher position in the tree are assigned fills first. Once the Exit Allocation with the highest priority receives its maximum allowable filled quantity, the next Exit Allocation is given a filled quantity to manage. Each fill event creates an Exit Allocation that is completely independently managed.

In Step 150, the trading system waits for trail events, if a trail is being used. If there is a trailing strategy associated with the exit allocation, then the exit allocation will wait for events specified in the trailing strategy in order to move the price of the profit or stop order. The trailing strategy is specified in steps 510-600.

### Complete a Trade

In Step 160, the trading system waits for profit or stops to fill and also waits for more fills from the Entry Allocation if there are any left. Once all of the entry and exit allocation have filled, the trade is complete.

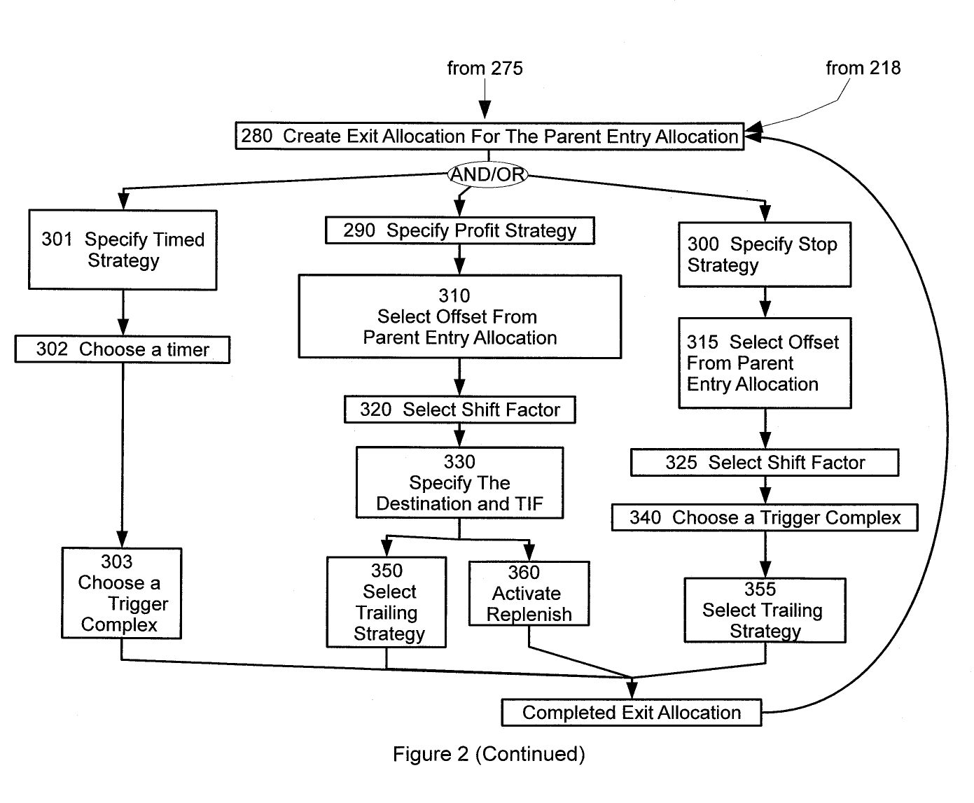

With reference to FIG. 2 and according to one embodiment of the present invention, in Steps 210 to 360, a method of defining trade parameters is described.

### Create an Allocation Tree

In Step 210, the Allocation Tree is created. This Allocation Tree always has a unique name since the name is used to specify its use when running the system in Steps 10-160.

In Step 215, one of three trade types, the CounterTrend trade, the Breakout trade or the Intellitrade trade is chosen. This is the same as Step 10 in FIG. 1, however it has been given a new number here for ease of reference within the scope of FIG. 2. The CounterTrend and Breakout trades are used to launch entry orders from the system into the market. The CounterTrend trade will place bids and offers (limit orders) into the market, thereby adding liquidity, while the Breakout trade removes pending bids and offers from the market by matching a trade quantity with an advertised quantity, thereby removing liquidity. The CounterTrend and Breakout Trees are composed of a collection of Entry Allocations each of which contains a collection of Exit Allocations. The IntelliTrade never launches entry orders, but instead is used to apply an automated exit strategy from orders that had been manually entered by the trader. For this reason, the IntelliTrade tree is simply a collection of Exit Allocations.

In Step 216, the user has chosen to create a CounterTrend tree type, and the next step is Step 230.

In Step 217, the user has chosen to create a Breakout tree type, and the next step is Step 231.

In Step 218, the user has chosen to create an Intellitrade tree type. Entries are manually entered by the user and the next step is Step 280.

### Define Trade Entry Conditions

In Step 230 the CounterTrend trade has been chosen, and a CounterTrend Entry Allocation is created. Each Entry Allocation specifies an entry strategy relative to the reference level price described in step 30. The user assigns an allocation percentage value to each Entry Allocation when it is created. This percentage indicates the amount of the total trade size that will be managed by the Entry Allocation once it is instantiated at runtime. The sum of all entry allocations must add up to 100% in order to create a valid CounterTrend trade. Therefore, each Entry Allocation created must not allocate a percentage that would cause the sum of all the entry allocations to exceed 100%.

In Step 231 the Breakout trade has been chosen and the Breakout Entry Allocation is created. The percentage assigned to the Entry Allocation is the same process described in step 230. All Entry allocations percentages must also add up to 100% in order to create a valid Breakout trade, and each Entry Allocation created must allocate a percentage that would case the sum of all the entry allocations to exceed 100%. The Breakout Entry Allocation must be associated with a Trigger Complex (created in steps 410-500) in order to be a valid Entry Allocation.

### Define Trade Entry Characteristics

In Step 232, a cancel condition can be set. Cancel conditions are a set of parameters that can signal the Entry Allocation to deactivate itself. This will result in the CounterTrend Entry Allocation canceling any orders placed. The cancel condition can be set to a timer that will deactivate the Entry Allocation after a certain period of time. Both the minutes and the seconds can be set on the timer.

In Step 240, the offset of the entry allocation from the level is specified by the user. The offset from the level determines where the entry allocation will be placed relative to the level price used on the tree as described in step 30. Negative offsets move the entry allocation closer to the current best bid/offer while positive offsets move the entry allocation farther from the best bid/offer. An offset of zero sets the entry allocation price equal to the level price used for the tree.

In Step 250, the shift factor is selected. The shift factor is used to specify how an entry or exit allocation offset will change once a shift is applied to the tree. Three types of shifts may be applied to a CounterTrend tree, that is entry, profit and stop shifts. When a shift is applied to the tree, it enlarges the offset of the Allocation, thereby changing the execution price of the Allocation (described in step 20). An arithmetic shift factor is multiplied by the shift that the user applies to a tree and this value is then added to the current offset. A geometric uses the shift factor as the base, and the user's shift input as the exponent, and this value is then added to the current offset. The shift factor allows the trader to quickly change the offsets of a tree after the tree is created. Note that a shift factor of zero will prevent the offset of an Allocation from changing if a shift is applied to the tree.

In Step 260, the destination and Time in Force (TIF) are specified. The destination is used to determine which securities exchange a limit order will be placed on. Note that this setting is only required if the system is used to trade stocks. The TIF is used to specify when the limit order will be canceled by the exchange. A TIF set to “Day” will ensure the order remains in the market for the current day, while a TIF of “Immediate” or “Cancel” will immediately cancel a limit order if it is not filled when placed. The TIF can also be set as “Good to Cancel” (GTC), indicating that the order will remain in the market until it is cancelled.

In Step 262, a cancel condition can be set. Cancel conditions are a set of parameters that can signal the Entry Allocation to deactivate itself. This will result in the deactivation of a Trigger Complex associated with a Breakout Entry Allocation. The cancel condition can be set to a timer that will deactivate the Entry Allocation after a certain period of time. Both the minutes and the seconds may be set on the timer.

In Step 264, the offset of the entry allocation from the level is specified by the user. The offset from the level determines where the entry allocation will be placed relative to the level price used on the tree. Negative offsets move the entry allocation closer to the current best bid/offer while positive offsets move the entry allocation farther from the best bid/offer. An offset of zero sets the entry allocation price equal to the level price used for the tree.

In Step 266, the shift factor is selected. The shift factor is used to specify how an entry or exit allocation offset will change once a shift is applied to the tree. Three types of shifts may be applied to a Breakout tree, that is entry, profit and stop shifts. When a shift is applied to the tree, it enlarges the offset of the Allocation, thereby changing the execution price of the Allocation (described in step 20). An arithmetic shift factor is multiplied by the shift that the user applies to a tree and this value is then added to the current offset. A geometric uses the shift factor as the base, and the user's shift input as the exponent, and this value is then added to the current offset. The shift factor allows the trader to quickly change the offsets of a tree after the tree is created. Note that a shift factor of zero will prevent the offset of an Allocation from changing if a shift is applied to the tree.

In Step 270, a Trigger Complex is chosen. The Trigger Complex is used to specify how the current allocation will remove liquidity from the market. The user must create a Trigger Complex before it can be used in an Allocation Tree and at this point the method executes Steps 410 to 500, which set out the Trigger Complex procedure and then returns to perform the next step, Step 280.

In Step 275, the entry allocation is completed.

### Define Trade Exit Conditions

In Step 280, Exit Allocations may be created for parent Entry Allocation. Each Entry Allocation created in the tree can be assigned zero or more Exit Allocations. The Exit Allocations determine how the order will be managed once its parent Entry Allocation has been filled in the market. An Exit Allocation is assigned a percentage by the user which indicates what percent of the trade size assigned to its parent Entry Allocation will be managed by the Exit Allocation. The percentage assigned must be less than or equal to the amount not yet assigned by other exit allocations for the parent Entry Allocation. If an exit allocation is created, it must contain at least one profit, stop or timed strategy, but may contain any combination of the three.

### Specify an Exit Strategy

In Step 290, the profit strategy is specified. The profit strategy determines where a limit order is to be placed once the parent Entry Allocation is filled. The profit limit order is always initially placed on the side of the market that will result in a profitable trade if it is filled. The profit price is the maximum amount of profit that can be attained, and this price is determined at runtime once the parent Entry Allocation is filled. When specifying a profit strategy, steps 310-330 are required in order to create a valid strategy.

In Step 300, a stop strategy is specified. The stop strategy determines where a Trigger Complex will be placed once the parent Entry Allocation is filled. The stop strategy is always initially placed on the side of the market that will result in a losing trade if the Trigger Complex is activated. The Price that the Trigger Complex is set at is the minimum amount of loss that can be attained, and the price of the root trigger in the Trigger Complex is determined at runtime (See steps 410-500). The actual filled price that the stop strategy attains depends on the number of triggers in the complex, how each trigger is configured, and what market events occur at runtime. When specifying a stop strategy, steps 315, 325, and 340 are required in order to create a valid stop strategy.

In step 301, a timed strategy is specified. The timed strategy will execute after a specific amount of time has elapsed. For example, if the user wants to exit a position after 5 minutes and 10 seconds, then this strategy would be used. When specifying a timed strategy, steps 302 and 303 are required in order to create a valid timed strategy.

### Define Trade Exit Characteristics

In step 302, the timer is chosen. The user can set the number of minutes and seconds on the timer. The timer is activated once the Exit Allocation is assigned a filled quantity by the Entry Allocation.

### Define a Trigger Complex

In step 303, the user specifies which Trigger Complex will be used once the timer specified in step 302 expires. At this point, the method executes Steps 410 to 500, which set out the Trigger Complex procedure and then returns to perform the next step, step 280.

### Define Trade Exit Characteristics

In Step 310, the offset of the profit order from the parent entry allocation is specified. The offset specifies where the profit order will initially execute relative to their parent Entry Allocation. At runtime, once the level is applied to the tree and the price of the Entry Allocations is determined, the price of each Exit Allocation component can be determined based on this offset. The price of these orders may later be modified by trailing strategies, selected in Step 350, if applied to the Exit Allocation.

In Step 315, the offset of the stop strategy from parent entry allocation is specified. The offset specifies where Root Trigger of the Trigger Complex selected in step 340 will be placed relative to the parent Entry Allocation. At runtime, once the level is applied to the tree and the price of the Entry Allocations is determined, the price of each Exit Allocation component can be determined based on this offset. The price of these orders may later be modified by trailing strategies, selected in Step 355, if applied to the Exit Allocation.

In Step 320, the shift factor is selected. The shift factor is used to specify how an Entry or Exit Allocation offset will change once a shift is applied to the tree. Three types of shifts may be applied to a CounterTrend or Breakout tree, that is entry, profit and stop shifts, while two types of shift may be applied to an IntelliTrade Tree, that is, profit or stop shifts. When a shift is applied to the tree, it enlarges the offset of the Allocation, thereby changing the execution price of the Allocation (described in step 20). An arithmetic shift factor is multiplied by the shift that the user applies to a tree and this value is then added to the current offset. A geometric shift uses the shift factor as the base, and the shift as the exponent, and this value is then added to the current offset. The shift factor allows the trader to quickly change the offsets of a tree after the tree is created. Note that a shift factor of zero will prevent the offset of an Allocation from changing if a shift is applied to the tree.

In Step 325, the shift factor is selected. The shift factor is used to specify how an Entry or Exit Allocation offset will change once a shift is applied to the tree. Three types of shifts may be applied to a CounterTrend or Breakout tree, that is entry, profit and stop shifts, while two types of shift may be applied to an IntelliTrade Tree, that is, profit or stop shifts. When a shift is applied to the tree, it enlarges the offset of the Allocation, thereby changing the execution price of the Allocation (described in step 20). An arithmetic shift factor is multiplied by the shift that the user applies to a tree and this value is then added to the current offset. A geometric shift uses the shift factor as the base, and the shift as the exponent, and this value is then added to the current offset. The shift factor allows the trader to quickly change the offsets of a tree after the tree is created. Note that a shift factor of zero will prevent the offset of an Allocation from changing if a shift is applied to the tree.

In Step 330, the destination and Time in Force (TIF) are specified. The destination is used to determine which securities exchange a limit order will be placed on. Note that this setting is only required if the system is used to trade stocks. The TIF is used to specify when the limit order will be canceled by the exchange. A TIF set to “Day” will ensure the order remains in the market for the current day, while a TIF of Immediate or Cancel will immediately cancel a limit order if it is not filled when placed. The TIF can also be set as Good To Cancel (GTC), indicating that the order will remain in the market until it is cancelled.

### Define a Trigger Complex

In Step 340, the Trigger Complex is chosen. The Trigger Complex is used to specify how the current allocation will remove liquidity from the market. The user must create a Trigger Complex before it can be used in an allocation tree and at this point, the method executes Steps 410 to 500, which set out the Trigger Complex procedure and then returns to perform the next step, Step 355.

### Select a Trailing Strategy

In Step 350, a trailing strategy is selected. A trailing strategy used with a profit strategy is used to specify how the price of the profit order will be changed at runtime. A trailing strategy must be created before it is used in the Allocation Tree. A trailing profit strategy will move the profit to a less profitable price if the market moves against the filled parent Entry Allocation. At this point, the method executes Steps 510 to 600, which set out the trailing strategy procedure and then returns to the present procedure. A trailing strategy which does nothing is also a trailing strategy. A trailing strategy is optional.

In Step 355, a trailing strategy is selected. A trailing strategy used with a stop strategy is used to specify how the price of the Trigger Complex will be changed at runtime. A trailing strategy must be created before it is used in the Allocation Tree. A trailing stop strategy will move the Trigger Complex to a more profitable price if the market moves in the favor of the filled parent Entry Allocation. At this point, the method executes Steps 510 to 600, which set out the trailing strategy procedure and then returns to perform the next step. A trailing strategy which does nothing is also a trailing strategy. A trailing strategy is optional.

In Step 360, the replenish feature is activated. Replenish is used to reenter the Entry Order once the profit order is filled. The user can specify the total number of cycles that will be replenished, and the Exit Allocation will continue to replace the Entry Order as long as this cycle number is not exceeded. Choosing to replenish is optional.

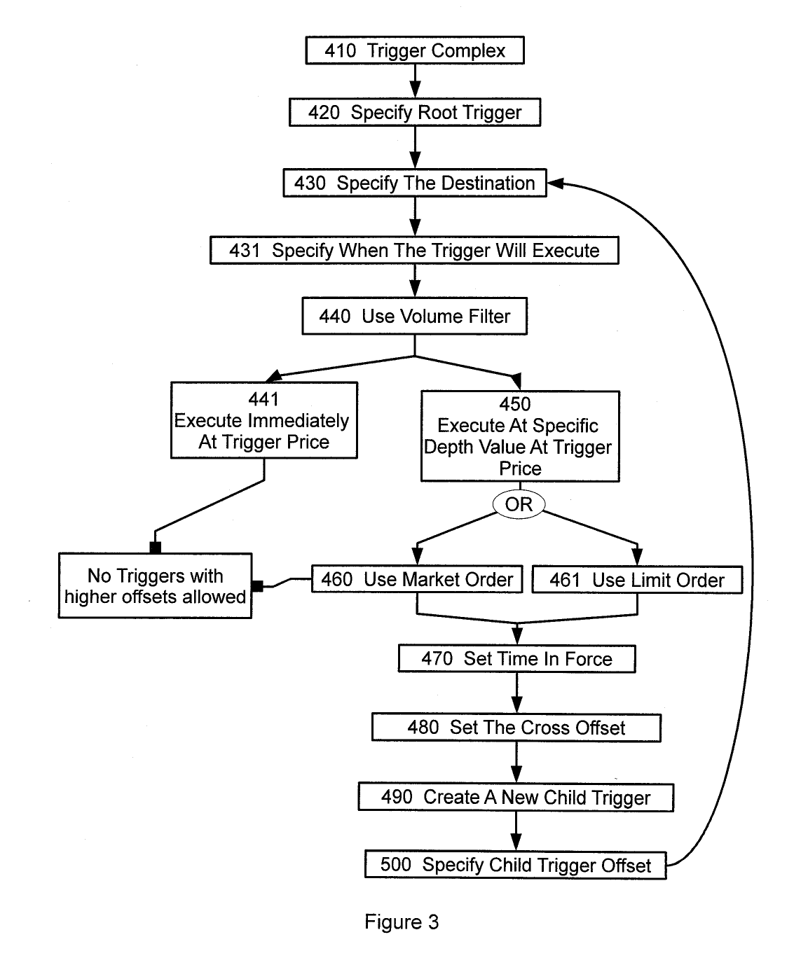

With reference to FIG. 3 and according to one embodiment of the present invention, a method of defining a trigger complex is defined in Steps 410-500.

### Define a Trigger

In Step 410, the Trigger Complex is created by the user. The Trigger Complex is used anytime the trader wants to buy or sell a product from pending orders placed in the market by other traders, thereby removing liquidity from the market. The Trigger Complex is composed of a collection of triggers that are able to execute specific trade instructions once certain conditions are satisfied. The Trigger Complex must have a root trigger, but may have many more triggers depending on how it is designed by the user. The complex must have a unique name to ensure that there is no ambiguity when it is used. At runtime, the complex is provided an orientation that specifies if each trigger will execute a Long (buy order) or a Short (sell order). The complex is also provided with an entry size, which specifies how large of an order each trigger will use for execution. The complex is also provided with a Root Trigger price which is extrapolated from its parent Allocation Tree and this is used to derive the prices of any Child Triggers in the complex (see step 110).

In Step 420, the user specifies the Root Trigger. The Root Trigger must always be specified in order to create a valid Trigger Complex, otherwise the collection of triggers in the Trigger Complex would be empty and the Child Triggers would have no reference point to validate their offsets. The Root Trigger always has an offset of zero, since the offset of all other Child Triggers are relative to the Root Trigger.

### Define Execution Conditions for Trigger

In Step 430, the destination is specified by the user. See step 330 for more information about the options for setting the destination.

In Step 431, the user specifies the specific trigger event that will launch a trade at the trigger price. The user may either use a price point to activate a trigger event or a price point in conjunction with market depth at that price.

In step 440, a Volume Filter may be selected. Volume represents transactions on the market where the orders of a buyer and seller are matched by the exchange. The volume filter specifies a minimum amount of volume that must occur at the trigger price before the trigger event is fired. The volume can be measured in number of shares traded (for securities) or the number of contracts traded (for derivatives). The volume filter is an additional criterion that must be satisfied in addition to any other conditions set in the trigger before the trigger is to be activated (i.e. depth conditions set in step 550, or price conditions set in the offset). This step is optional.

### Execute Trigger at Trigger Price

In Step 441, the user specifies that the trigger will only use price information to activate the trigger. This means as soon as the trigger price is equal to the price of the current best bid or offer, the trigger is able to activate. If the market order is used in this step, no triggers can be created with a higher offset (see step 460 for a description of a market order).

In Step 450, the user specifies that the trigger event will be both price and depth based. As soon as the trigger price is equal to the current best bid or offer, and the depth at this price is lower than the trigger threshold, the system activates the trigger. The depth value is the number of shares (when trading stocks) or contracts (when trading futures), that are being advertised to buy or sell at a specific price point. The trader can specify the amount of depth that must be at a price point before executing an order.

### Use a Market or Limit Order

In Step 460, a market order is selected. A market order is a type of order that guarantees the trade will be filled, but does not guarantee a specific execution price. This is an order type that is offered by the exchange. If the market order is used in the complex, it must always have the highest offset, and only one trigger can use a market order in the Trigger Complex.

In Step 461, a limit order is selected. A limit order is a type of order that guarantees the trade is executed at a specific price, but does not guarantee that it will be filled. This is also an order type that is offered by the exchange.

### Set Exit Conditions

In Step 470, the Time in Force (TIF) is selected. The TIF is used to specify when the limit order will be canceled by the exchange. A TIF set to “Day” will ensure the order remains in the market for the current day, while a TIF of Immediate or Cancel will immediately cancel a limit order if it is not filled when placed. The TIF can also be set as Good To Cancel (GTC), indicating that the order will remain in the market until it is cancelled.

In Step 480, the cross offset is set by the user. “Crossing the market” by use of a cross offset refers to placing a buy order higher than or equal to the best offer, or a sell order lower than or equal to the best bid. Setting the cross offset to a value other than zero will execute the trade at a price outside of the best bid or offer, increasing the probability that the limit order will be filled when it is placed. This allows the trader to specify a limit on the execution price, while greatly increasing the chances of receiving a fill. The cross offset is relative to the trigger price, and the execution price of the order will be determined at run time, once the trigger is assigned its price by the Trigger Complex.

### Create Child Triggers

In Step 490, a new Child Trigger is created. The Child Trigger offset is relative to the Root Trigger price. The price of the child triggers depends on the orientation of the Trigger Complex (long or short) and the offset from the root. If the orientation of the Trigger Complex is long, the offset is added to the root trigger price, and the offset is subtracted from the root trigger price if the orientation is short. This step is optional.

In Step 500, the Child Trigger Offset is specified. Specifying offsets instead of specific prices at design time allows the Trigger Complex to be reused at any price on any product. There is no limit to the number of Child Triggers in the Trigger Complex, and each Child Trigger can have unique specifications.

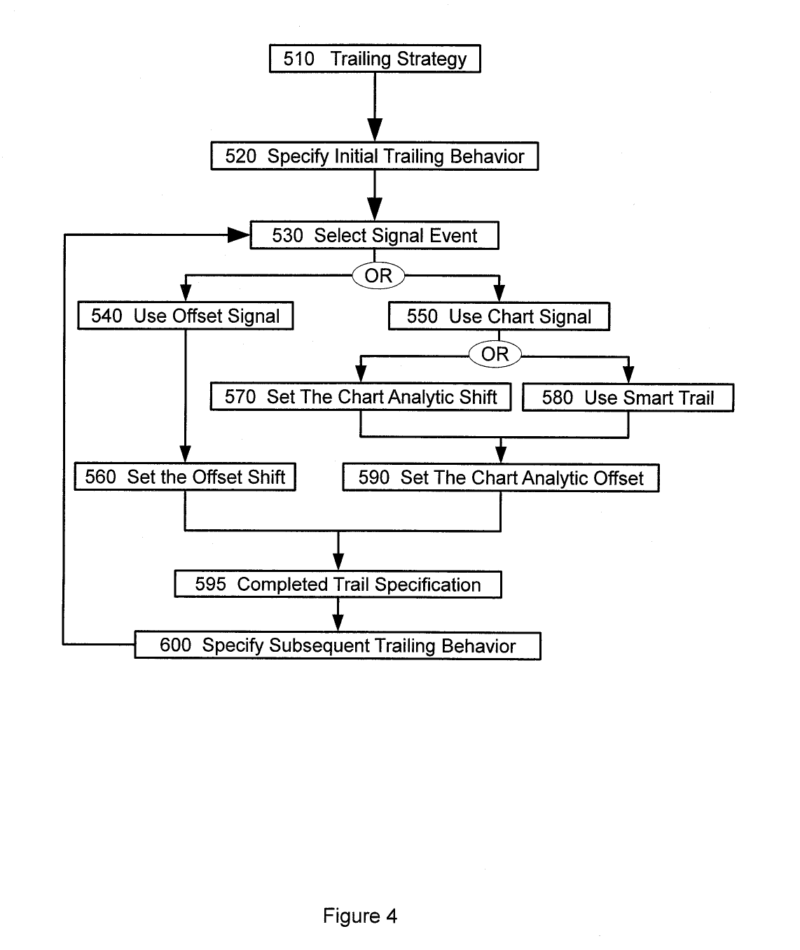

With reference to FIG. 4, and according to one embodiment of the present invention, a method of defining a trailing strategy is described in Steps 510-600.

### Specify Trailing Behavior

In Step 510 the trailing strategy is created. The trailing strategy is a way of changing the price of an order in response to market conditions. The trailing strategy is broken into two phases: an initial phase which allows the user to specify how the order will trail the first time, and a subsequent phase which describes how the order will trail after the initial phase is complete. Once the trailing strategy is created, it can be linked with either a profit order or a stop strategy. Stop strategies are only moved when the market moves in a more profitable direction for the trade, while profit orders are only moved when the market moves against the trade entry.

In step 520, the initial trailing behavior is set. The initial trailing behavior is the first trailing event that occurs, and is only executed once. The initial trailing event occurs once the initial signal, specified in steps 540 or 550 is triggered, and the initial shift, specified in step 560, 570 or 580 is carried out. The initial trailing behavior must always be specified in order to create a valid trailing strategy. Once the initial trailing shift is executed at runtime, the subsequent behavior is then activated (if one is specified).

### Select Signal Event

In step 530, the signal event is selected. The signal event can be of two types: offset signal or chart signal. A signal event specifies the criteria that must occur before the trailing shift is activated.

### Select Trailing Parameters

In step 540, the offset signal is specified. The offset signal uses an offset to specify how far the market must move from filled Entry Allocation before applying the offset shift specified in Step 560, each offset interval represents one price increment. The price of the offset signal is determined at runtime, once the trailing strategy is associated with an Allocation Tree and once step 110 is complete.

In Step 550, a chart signal is used. A chart signal uses the end of a sampling interval to signal the event. The user can choose from many different standard sampling intervals. During each sampling interval a variety of analytics are collected, which can be later used in the chart analytic shift. These analytics include significant price points such as the high or low price points that were traded during the sampling interval. For example, if the user specifies a 5 minute chart signal, then the price of the trailing strategy will only be updated every 5 minutes.

In Step 560, the user sets the offset shift. The offset shift is an offset that indicates how many price increments the profit/stop strategy will be moved once the signal is activated (specified in step 540). Every time the offset signal is activated, then the shift is applied.

In Step 570, the Chart Analytic Shift is set. Each time the signal is detected, the trailing order will be shifted to a specific chart analytic. For example, if the 5 minute chart signal is used in step 550, then the trailing strategy can be shifted to the lowest price or the highest point traded in that 5 minute interval, depending on the orientation of the trade.

In Step 580, Smart Trail is applied. Smart trail is a custom trailing algorithm that will only shift an order after a specific pattern occurs in the chart analytic events. The algorithm will shift the order only after a pullback is detected and then, a reconfirmation of the original trend. The analytic that is used is dependent on the orientation of the original order and whether or not a stop or profit is being shifted. For example, if the original entry is long and we are shifting a stop order via the smart trail algorithm, a pullback is defined as a chart analytic that has a lower or equal low than the previous sampling; a pullback will continue until a reconfirmation is detected. A reconfirmation is defined as a chart analytic which closes with a higher low then the previous chart analytic. Once a reconfirmation is detected the system will move the stop to the bottom of the chart analytic previous to the one which established the reconfirmation plus or minus an offset which the user defines. If the original orientation of the entry is short and the system is shifting a stop-loss order via the smart trail algorithm, a pullback is defined as a chart analytic that has a higher or equal high than the previous sampling; a pullback will continue until a reconfirmation is detected. A reconfirmation is defined as a chart analytic which closes with a lower high than the previous chart analytic. Once a reconfirmation is detected the system will move the stop to the top of the chart analytic previous to the one which established the reconfirmation, plus or minus the offset defined by the user.

In Step 590, the analytic offset can be selected. This allows the user to offset from the shifted analytic price detailed in step 570 and 580. For example, if the user wants to offset the shifted price into the range of the chart analytic, a positive offset can be used, while a negative offset will move the shifted price outside of the range of the chart analytic. This step is optional.

### Complete Trail Specification

In Step 595, the trail specification is completed.

### Specify Subsequent Trailing Behavior

In Step 600, the subsequent trailing behavior is specified. This allows the user to select a recurring behavior that will occur after the initial trailing event has occurred. All of the trailing options available to the initial trailing behavior are also available when specifying the subsequent behavior. This step is optional.

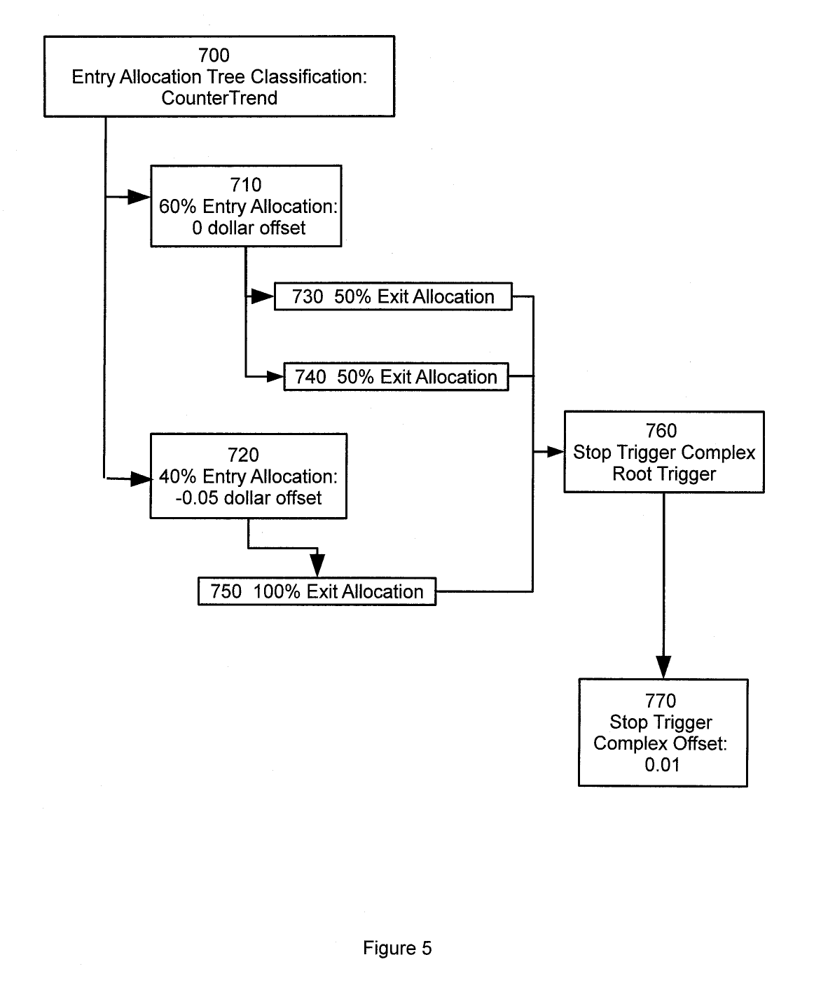

With reference to FIG. 5, and according to one embodiment of the present invention, steps 700-770 represent an example of the creation of a simple CounterTrend Allocation Tree.

The structures of the template in FIG. 5 could represent either a Breakout strategy or a CounterTrend strategy but would not represent an Intellitrade strategy because entry strategies are specified in steps 710 and 720, which specification precludes the possibility of a non-system entry. In all cases, Intellitrade strategy templates include only one 100% entry allocation with parameters that cannot be defined.

The template represented in steps 700-770 does not in any way represent the full functionality of this invention's template building capabilities; instead these diagrams serve merely as an example and are designed to aid in the comprehension and visualization of this invention's basic functions.

In Step 700 the user defines the Allocation Tree as CounterTrend.

In Step 710 the user defines an entry as having an offset of 0.00 from the reference price to be determined at launch, and will manage 60% of the position size to be determined at launch.

In Step 720 the user defines an entry as having an offset of −0.05 from the reference price to be determined at lunch, and will manage 40% of the position size to be determined at launch.

In Step 730 the user defines an exit that will manage 50% of the position issued to it from the execution price of its superset entry position defined in Step 700. The user defines a profit order offset of 0.03 and a stop order offset of 0.04

In Step 740 the user defines an exit that will manage 50% of the position issued to it from the execution price of its superset entry position defined in Step 700. The user defines a profit order offset of 0.10 and a stop order offset of 0.04.

In Step 750 the user defines an exit that will manage 100% of the position issued to it from the execution price of its superset entry position defined in Step 710. The user defines a profit order offset of 0.06 and a stop order offset of 0.06.

In Step 760 the user attaches a Trigger Complex to the stop orders defined in Steps 730, 740, and 750. The user defines the root trigger conditions of the stop trigger complex as having a depth threshold of 3000 shares, a Time In Force of “Day”, a cross offset of 0.00, and a volume threshold of 100 shares, indicating that this complex will not initiate until the market depth at the price, to be determined based on the specific execution price of its superset exit allocation, crosses a threshold of 3000 shares and a volume print of at least 100 shares is issued at the same price, to be determined based on the specific execution price of its superset exit allocation. Once the root trigger conditions are satisfied this invention will place a “Day” order at the relevant bid or offer that will attempt to remove liquidity from the market.

In Step 770 the user defines an offset trigger to the stop trigger complex with an offset of 0.01. The user defines that this offset will place an immediate market order. The offset trigger will only initiate if the product price reaches one interval higher or lower (dependent on orientation) than the root trigger price, to be determined based on the specific fill price of its superset exit allocation. The offset trigger will also only initiate if the root trigger did not fully exit the position that it was issued.

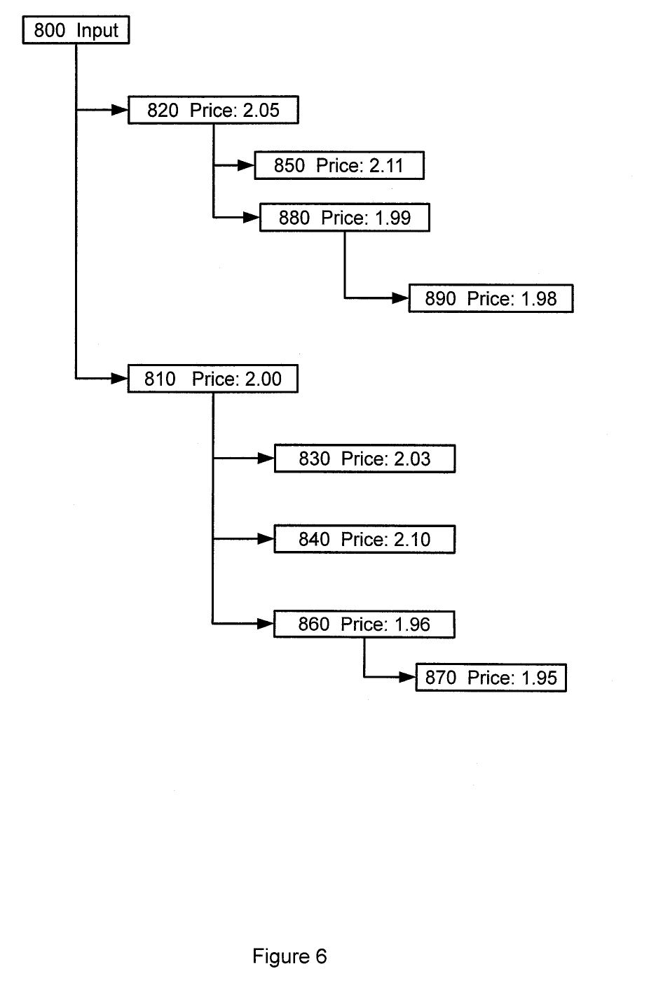

With reference to FIG. 6, and according to one embodiment of the present invention, an example of an Allocation Tree instantiation is displayed. In Step 800 the user applies the trading strategy template defined in FIG. 5 to a level price of 2.00, on a financial instrument with price intervals of 0.01, with a position size of 1000 shares. This invention extracts from the front end trading platform that the current best market price of the product is bid: 2.10 and offer: 2.11. This invention extrapolates from the strategy classification, level price, and market price that the orientation of this trading strategy template is long.

In Step 810 this invention places a 600 share entry buy order at 2.00 according to the trading strategy template design parameters outlined in step 700.

In Step 820 this invention places a 400 share entry buy order at 2.05 according to the trading strategy template design parameters outlined in Step 710.

In Step 830 this invention will place a 300 share profit order at 2.03 according to the trading strategy template design parameters outlined in Step 730 once its superset entry parameters have been filled by the exchange.

In Step 840 this invention places a 300 share profit order at 2.10 according to the trading strategy template design parameters outlined in Step 740 once its superset entry parameters have been filled by the exchange.

In Step 850 this invention places a 400 share profit order at 2.11 according to the trading strategy template design parameters outlined in Step 750 once its superset entry parameters have been filled by the exchange.

In Step 860 this invention will activate the root trigger of the stop trigger complex defined in Step 760 at 1.96 once the conditions outlined in Step 760 are satisfied.

In Step 870 this invention will activate the offset trigger of the stop trigger complex defined in Step 770 at 1.95 once the conditions outlined in Step 770 are satisfied.

In Step 880 this invention will activate the root trigger of the stop trigger complex defined in Step 760 at 1.99 once the conditions outlined in Step 760 are satisfied.

In Step 890 this invention will activate the offset trigger of the stop trigger complex defined in Step 770 at 1.98 once the conditions outlined in Step 770 are satisfied.

As used in the claims, the terms condition precedent and the term condition subsequent refer to conditions based on which other actions are predicated or terminated. For example, a trigger occurs on an occurrence or absence of a condition.

Many modifications and other embodiments of the invention will come to the mind of one skilled in the art having the benefit of the teachings presented in the foregoing description and associated drawings. Therefore, it is understood that the invention is not to be limited to the specific embodiment disclosed, and that modifications and embodiments are intended to be included within the scope of the appended claims.

1. A method comprising:
providing at least a trading template;
selecting a first trading template from the at least a trading template;
receiving via a communication network data relating to at least a trade relating to the first trading template;
modifying the first trading template in accordance with a shift, the shift for adjusting the first template;
automatically communicating via a network with a trading server to receive data for use in evaluating at least a condition precedent of the shifted trading template; and,
when the at least a condition precedent is met, automatically communicating via the network with the trading system to request a first trade thereon in accordance with the first trading template.

2-64. (canceled)
